(19) United States
(12) Patent Application Publication
(10) Pub. No.: US 2013/0304777 A1
(43) Pub. Date: Nov. 14, 2013

(54) MAPPING METADATA ON IMPORT OF A MUSIC LIBRARY

(71) Applicants: Brandon Bilinski, San Francisco, CA (US); Alexander Collins, San Francisco, CA (US)

(72) Inventors: Brandon Bilinski, San Francisco, CA (US); Alexander Collins, San Francisco, CA (US)

(73) Assignee: Google Inc., Mountain View, CA (US)

(21) Appl. No.: 13/467,823

(22) Filed: May 9, 2012

(51) Int. Cl. G06F 17/30

(52) U.S. Cl. 707/828; 707/E17.009

(57) ABSTRACT

A method for uploading a music library to a music provider service is provided. The method initiates with identifying a music library for uploading, the music library including at least one music file, the music file including audio data and associated metadata fields. A mapping between the metadata fields of the music file and metadata fields of a destination file corresponding to the music file is then defined. The destination file is created at the music service provider by copying the audio data to the destination file and by copying contents of the metadata fields of the music file to the metadata fields of the destination file according to the mapping.

### BACKGROUND

1. Field of the Invention

The present invention relates to methods, systems, and computer programs for mapping metadata on import of a music library.

2. Description of the Related Art

Internet applications have grown tremendously over the years and so have the functionality provided to devices that access those applications. One area that has seen such growth relates to audio file management. As users continue to purchase and store more audio music files on their devices, management of those files becomes ever more important. Commonly, users have music libraries on various devices and those devices are usually backed up from time to time. If a user has more than one device, more synchronization is necessary to ensure that each device has access to the desired music. As users upgrade their devices or lose their devices, added complexities arise in syncing new devices to older music libraries. Many times, the management becomes so extensive that users lose some or most of their libraries.

To address these issues, services are now being provided to allow online cloud storage of their music files. However, improvement is still needed to address various challenges posed by cloud storage and to enable new features for interfacing with a user's music library. One area in which improvement may be sought concerns the importation of music files from a local music library to a cloud-based music library. It is in this context that embodiments arise.

### SUMMARY

Embodiments of the present invention provide methods, systems, and computer programs for mapping metadata on import of a music library. It should be appreciated that the present invention can be implemented in numerous ways, such as a process, an apparatus, a system, a device or a method on a computer readable medium. Several inventive embodiments of the present invention are described below.

In one embodiment, a processor-implemented method for uploading a music library to a music provider service is provided. The method initiates with identifying a music library for uploading, the music library including at least one music file, the music file including audio data and associated metadata fields. A mapping between the metadata fields of the music file and metadata fields of a destination file corresponding to the music file is then defined. The destination file is created at the music service provider by copying the audio data to the destination file and by copying contents of the metadata fields of the music file to the metadata fields of the destination file according to the mapping.

In one embodiment, the mapping defines an association between a metadata field of the music file having a first type and a metadata field of the destination file having a second type different from the first type. Furthermore, the method operation of copying contents of the metadata fields of the music file to the metadata fields of the destination file includes copying contents, from the metadata field of the music file having the first type, to the metadata field of the destination file having the second type different from the first type.

In one embodiment, the first type and the second type are selected from the group consisting of artist, album artist, album, title, genre, and year.

In one embodiment, the method operation of defining the mapping includes presenting an interface for defining associations between the metadata fields of the music file and the metadata fields of the destination file, and receiving input via the interface.

In one embodiment, the mapping defines an association between two metadata fields of the music file and a single metadata field of the destination file. Furthermore, the method operation of copying contents of the metadata fields of the music file to the metadata fields of the destination file includes merging contents from the two metadata fields of the music file and writing the merged contents to the single metadata field of the destination file.

In one embodiment, the mapping defines an association between a single metadata field of the music file and two metadata fields of the destination file. Furthermore, the method operation of copying contents of the metadata fields of the music file to the metadata fields of the destination file includes copying contents from the single metadata field of the music file to each of the two metadata fields of the destination file.

In another embodiment, a tangible computer-readable medium is provided having program instructions for uploading a music library to a music provider service embodied thereon that, in response to execution by a computing device, cause the computing device to perform operations including the following: identifying a music library for uploading, the music library including at least one music file, the music file including audio data and associated metadata fields; defining a mapping between the metadata fields of the music file and metadata fields of a destination file corresponding to the music file; and creating the destination file at the music service provider by copying the audio data to the destination file and by copying contents of the metadata fields of the music file to the metadata fields of the destination file according to the mapping.

In another embodiment, a system for uploading a music library to a music provider service is provided. The system includes a library identification module for identifying a music library for uploading, the music library including at least one music file, the music file including audio data and associated metadata fields. A mapping module is configured for defining a mapping between the metadata fields of the music file and metadata fields of a destination file corresponding to the music file. A transfer module is configured for creating the destination file at the music service provider by copying the audio data to the destination file and by copying contents of the metadata fields of the music file to the metadata fields of the destination file according to the mapping.

Other aspects will become apparent from the following detailed description, taken in conjunction with the accompanying drawings.

### BRIEF DESCRIPTION OF THE DRAWINGS

The invention may best be understood by reference to the following description taken in conjunction with the accompanying drawings.

FIG. 1 illustrates a system diagram for enabling access and playing of music files stored in cloud storage, in accordance with one embodiment of the present invention.

FIG. 2 illustrates how user A utilizes a device 106 (e.g. smart phone) to access his or her music library stored in the cloud music storage (CMS) 116, in accordance with one embodiment of the present invention.

FIG. 3 illustrates how a user may upload music to their cloud-based music library, in accordance with an embodiment of the invention.

FIG. 4 illustrates mapping of metadata from a local audio file to a destination audio file, in accordance with an embodiment of the invention.

FIG. 5 illustrates a system for importing audio files to a cloud-based music service, in accordance with embodiments of the invention.

FIG. 6 illustrates a system for importing music files from a local music library to a remote music library, in accordance with embodiments of the invention.

FIG. 7 illustrates a system for supplementing metadata from a data provider, in accordance with embodiments of the invention.

FIG. 8 illustrates a method for importing music from an existing music library to a destination music library, in accordance with embodiments of the invention.

FIG. 9A illustrates a library selection interface for enabling a user to define an existing music library from which to import music to a second music library, in accordance with embodiments of the invention.

FIG. 9B illustrates a selection interface for choosing a metadata mapping template, in accordance with embodiments of the invention.

FIG. 10 illustrates a mapping interface for defining metadata mapping relationships between a source audio file and a destination audio file, in accordance with embodiments of the invention.

FIG. 11 illustrates an interface for setting the format of a particular metadata field, in accordance with embodiments of the invention.

FIG. 12 is a simplified schematic diagram of a computer system for implementing embodiments of the present invention.

### DETAILED DESCRIPTION

The following embodiments describe methods, computer programs, and systems for mapping metadata on import of a music library.

It will be apparent, that the present embodiments may be practiced without some or all of these specific details. In other instances, well known process operations have not been described in detail in order not to unnecessarily obscure the present embodiments.

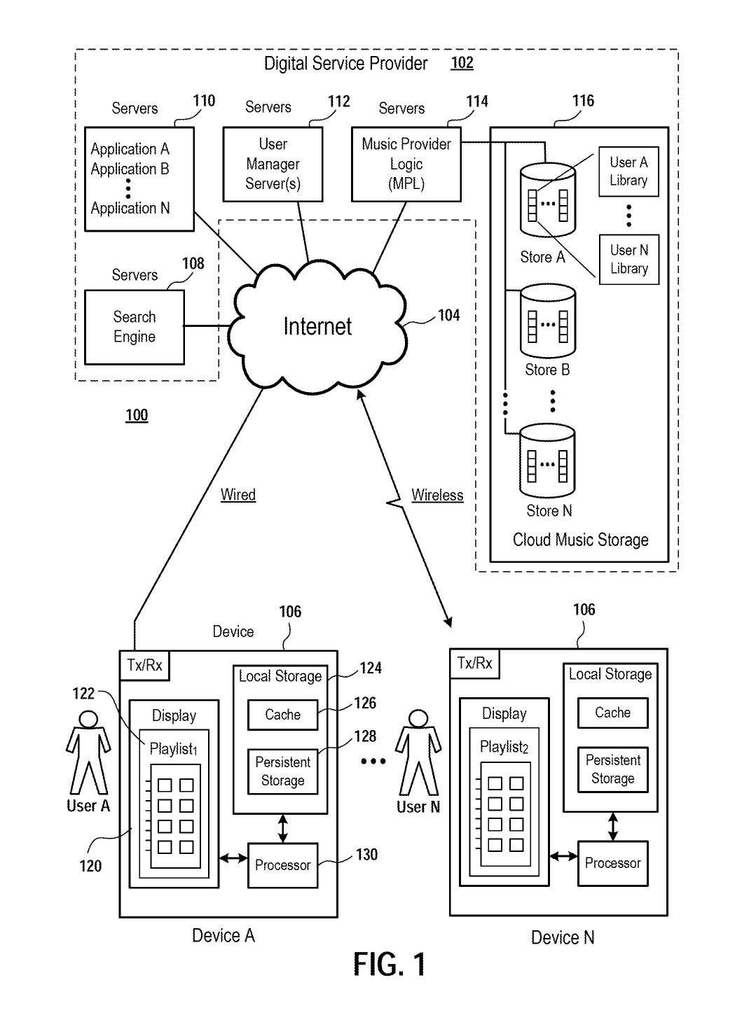

FIG. 1 illustrates a system diagram 100 that defines methods for accessing and playing music files stored in cloud storage, and improving the rate at which playing of a music file response to user selection, is disclosed in accordance with one embodiment of the present invention. The system includes a plurality of servers that are connected to the Internet 104. The plurality of servers and storage are, in one embodiment, part of a digital service provider 102. The digital service provider 102 is a system that can include a plurality of servers that can provide applications, services, digital content, and interconnectivity between systems, applications, users, and social networks. For example, the digital service provider 102 can include a search engine 108, a plurality of servers 110 that provide applications for various business, social, and technology related subject matter, servers that provide user management 112, and servers to provide music related services.

One example digital service provider 102 can be Google Inc., of Mountain View, Calif. Other digital service providers can be more focused to provide only specific services, while others provide a variety of services for access, download, viewing, searching, etc. The content can vary greatly, but is commonly presented in digital format and displayed on monitors or screens of devices, computers, smart phones, tablets, etc.

The servers that provide music related services, in one embodiment, are illustrated by the music provider logic (MPL) 114, which executes over one or more servers that are connected to the Internet 104. The music provider logic 114 is shown connected to cloud music storage 116. Cloud music storage 116 is shown to include a plurality of storage systems, identified as store A, store B, and store N. The various storage systems that hold music data and music metadata, are provided with fast access to the Internet, for providing music data on demand to users requiring access to their music library stored in cloud music storage 116. In one embodiment, users can access the cloud music storage 116 by way of a plurality of devices 106. The plurality of devices can include any type of device having a processor and memory, wired or wireless, portable or not portable. In the example illustrated in FIG. 1, user A is shown to have device 106 (device A). Device 106 is shown to include communication logic for transmitting and receiving data between device 106 and the Internet 104.

The communication logic (Tx/Rx) can include various types of network interface circuitry, radio-communication (e.g. wireless), cell tower communication, or interconnected wiring connected to Internet service providers. Device 106 is also shown to include a display having a screen 120, local storage 124, and a processor 130. Local storage 124 can include cache memory 126, persistent storage 128, and other logic. In this example, device 106 is shown to include graphical icons (e.g., graphical user interfaces GUIs) that represent a play list. The screen 120 can be a touch-screen, or a display typically provided by a flat-panel display, a cathode ray tube (CRT), or other media capable of rendering a display. Still further, device 106 can have its display separate from the device, similar to a desktop computer or a laptop computer. Still further yet, device 106 can be in the form of a smart phone, a tablet computer, or hybrids that provide touch-screen capability in a portable form factor. One example device can include a portable phone device that runs an operating system and is provided with access to various applications (apps) that may be obtained over the Internet, and executed on the local portable device (e.g., smart phone, tablet, laptop, desktop, etc.).

In one embodiment, the user of device 106 can install an application that provides cloud storage of music files, and access to the storage cloud music files from the device 106. Once the user's music files are uploaded to the cloud music storage 116, the user's music files are associated to a library of the user. In one embodiment, a plurality of users can access the same application and can upload their own music files to create their own library, which will be stored in the cloud music storage 116.

Each of such users can then access the cloud music storage 116 through an application on their device 106 to render and play selected music files on their device, when the device 106 has access to the Internet and associated servers of the music providing logic 114 and cloud music storage 116. Accordingly, users can access the music application on their device 106, access all music files stored in cloud music storage 116, arrange music titles in their music library into playlists, add music to the cloud music storage 116, delete music from the cloud music storage 116, and purchase music that is added to the cloud music storage 116. These changes are maintained and managed by the music provider logic 114 and music provider logic 114 will provide access to the various users to their music files stored in the cloud music storage 116, based on their selections during use of the application.

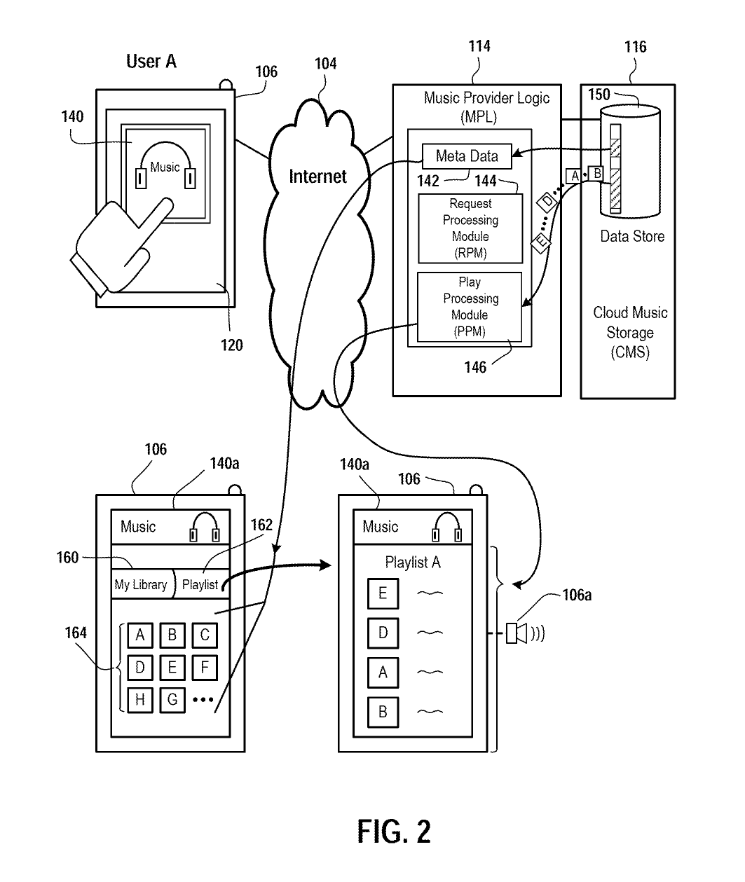

FIG. 2 illustrates how user A utilizes a device 106 (e.g. smart phone) to access his or her music library stored in the cloud music storage (CMS) 116, in accordance with one embodiment of the present invention. As shown, the device 106 will include a screen 120, and associated graphical icons that present a thumbnail of an application 140, associated with a music application. Application 140, as described herein, relates to an application that provides a user with access to his or her music library that has been previously added to the club music storage 116. If the user is a new user to the application 140, the new user can download application 140 to device 106 from at least one server 110 of the digital service provider 102.

Once the application has been downloaded and installed on device 106, the icon representing application 140 will be rendered on the display screen of device 106. Initially, the user will be prompted to select music to add to the cloud music storage 116. The music may be added from files currently maintained by the user on his or her device 106, on other devices of the user such as computers, other smart phone and or tablets, or other storage media. Additionally, the user can add music files that may be part of a music library maintained by another application. The other application may maintain a specific format for the music, and the music can be obtained and translated to standardize music files for addition to the cloud music storage 116.

Once the user has managed his library to add, modify, or adjust the music files present in the cloud music storage 116, the user can access application 140 and various options from graphical user interfaces provided on the screen 120 of device 106. In the illustrated example, device 106 will open application 140 through various graphical user interface screens, such as interface 140a. Interface 140a can include various menus, selection icons, configuration icons, displays, advertisements, buttons, listings, etc. In this example, the interface 140a may include an icon that lists the users library 160, the users play list 162, and music title icons 164. Music title icons can be represented by graphical artwork that represents artwork associated with the various music files present in the users library. The users library is illustrated by title icons 164, shown as A-H.

The title icons 164 are rendered on the screen 120 upon obtaining metadata from the cloud music storage 116, which may be present in data store 150. Music provider logic 114 will include request-processing module 144 that manages the requests and communication between various users applications 140 and the cloud music storage 116. The request processing module (RPM) 144 is also in communication with a play processing module (PPM) 146. In order to render the title icons 164 on the screen of the device 106, the music processing logic 114 will utilize the request processing module 144 to obtain metadata 142 from the data store 150.

The metadata 142 will be the metadata associated with the various music files stored in data store 150 for the requesting user. The metadata 142 provides information regarding each of the titles stored in the cloud music storage 116, and sufficient information to render the title icons 164 on the screen of device 106, and provide text information, duration information, genre information, and other data that describes aspects or characteristics of the music files. One example of metadata is an ID3 tag, which can contain information such as title, artist, album, year, track number, genre, etc. As shown, when the user selects play list 162 on device 106, a play list graphical user interface is shown identifying particular songs that have been arranged by the user.

The playlist A represents various songs that were selected by the user to be part of playlist A. The user can have various playlists, and the selection of playlist A is only provided as one example of a playlist that includes music files that are played in the order E→D→A→B. Once the user selects a corresponding play button or clicks on one of the audio files in the playlist, the music files will begin to play in the order arranged and defined by the user in his or her playlist A.

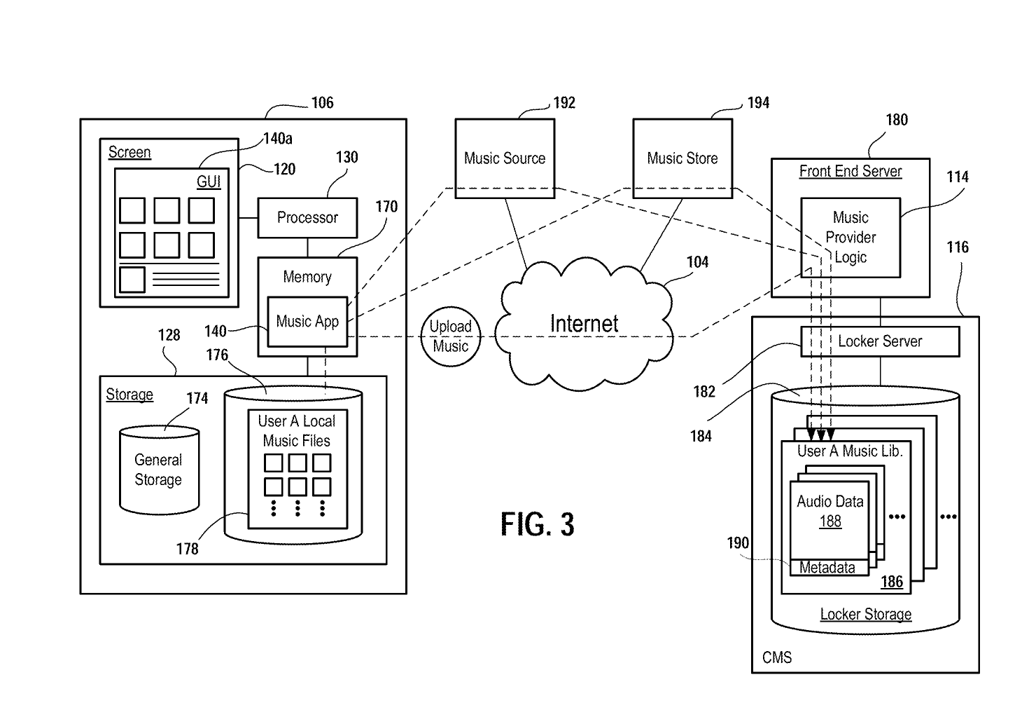

FIG. 3 illustrates how a user A may upload music to their cloud-based music library, in accordance with an embodiment of the invention. As shown, the music application 140 is executed in a memory 170 of the device 106. The device 106 includes persistent storage 128, which contains general storage 174 and local music storage 176. The local music storage 176 includes various music files 178 which the user A has stored on the device 106. The music application 140 provides an interface 140a shown on the display 120 of the device 106, which enables the user A to manually or automatically upload one or more of the music files 178 to the user's music library 186.

In one embodiment, the music application 140 detects the music files 178 and communicates with the music provider logic 114 via the Internet 104. The music provider logic 114 executes on a front end server 180. The music provider logic 114 communicates with a locker server 182, which manages access to a locker storage 184. The locker storage 184 contains various users' individual music libraries, including user A's music library 186. The music library 186 includes various audio files, each of which is defined by audio data 188 and associated metadata 190. Thus, in one embodiment, the music application 140 transmits one or more of the locally stored music files 178 to the music provider logic 144 which accesses the locker server 182 to store the music files within the user's music library 186.

It will be noted that music files from various other sources may also be uploaded to the user's music library 186. For example, music files from an external music source 192 that is available via the Internet 104 can be uploaded to the user's music library 186. In one embodiment, the music application 140 enables the user A to access, listen to, and authorize uploading of a music file from the external source 192. One example of an external music source is an online music store 194, from which the user A may purchase music for downloading to the user's music library. It will be appreciated that in the illustrated embodiment, by purchasing music from the music store 194, the user A causes a music file to be transferred from the music store 194 to the user A's music library 186. This is distinguished from a conventional online purchase where data is transferred to the user's client device. In the presently described embodiment, the data is transferred to a cloud-based storage library, which the user then accesses utilizing a client device 106.

For purposes of the present disclosure, a “song” shall refer to a canonical audio work, whereas an “audio file” or “music file” shall refer to a data file containing audio data that may be read or played so as to reproduce a previously recorded sound. Thus, each particular song is unique, whereas there may be many different types of audio files that encode the same song. A song is typically performed by an artist, and may be part of an album. A typical audio file may have any of various audio file formats, such WAV, MP3, AAC, WMA, FLAC, etc., and may include various types of metadata, such as that contained in ID3 tags. Despite having different meanings in a strict sense, it will be apparent that in many situations, the terms “song” and “audio file” or “music file” may each be accurately applied, or even used interchangeably. A music library consisting of a number of audio files can also be said to contain the various songs for which the audio files encode.

When audio files are imported from a local source to the cloud music storage 116 to become part of the user's music library 186, there may be situations when it becomes desirable to manage the import of metadata in accordance with embodiments of the invention. By way of example, the locally stored music files 178 may be part of an existing library associated with a third-party music player on the device 106. The usage of the metadata by the third-party music player may differ from the usage of metadata by the music provider logic 114 of the cloud-based music system. Therefore, simply importing music files as-is, with metadata fields of the local music files being copied to the same metadata fields in the corresponding files in the cloud-based music library 186 may result in a degraded user experience, as music files may be organized improperly, sorted improperly, or otherwise mishandled by the music provider logic 114.

By way of example, a local third-party music application may sort or present the user's music library according to particular fields of metadata. Thus the user will be accustomed to a specific mode of presentation of his/her local music library that is derived from the third-party music application's sorting or presentation schema. If the cloud-based music service utilizes different metadata fields for sorting or utilizes the same fields in a different way, then the presentation by the cloud-based music service may differ from the user's experience via the local third-party application. Such a scenario may be confusing for the user, making it perhaps difficult for the user to find or identify the music files in his cloud-based music library 186.

In another scenario, there may be metadata fields that are categorically ignored by the cloud-based music service, but which are populated in the locally stored music files. It may therefore be desirable to configure the mapping of metadata from the local file to the corresponding cloud-stored file so as to capture the information from those metadata fields that would otherwise be lost upon import.

Additionally, users may wish to customize the way in which metadata is mapped from the local music library to the cloud-based music library, so as to suit their own preferences with respect to the usage of metadata. Further, users may wish to customize the formatting of data stored in a given metadata field. In view of these various scenarios and others respecting the handling of metadata upon import of music files from an existing library or file system to a new library, embodiments of the invention as described herein provide systems and methods which address such issues.

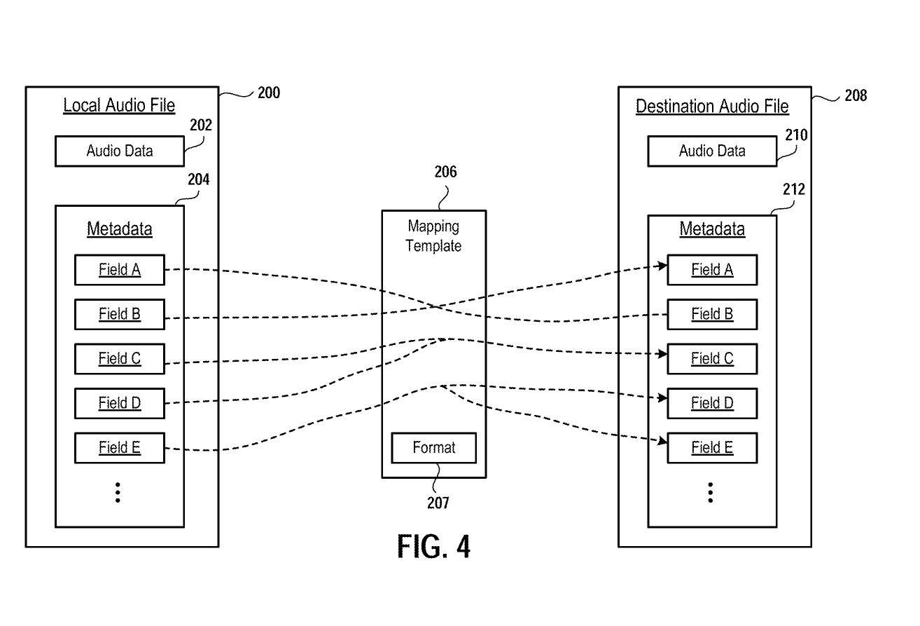

FIG. 4 illustrates mapping of metadata from a local audio file to a destination audio file, in accordance with an embodiment of the invention. A local audio file 200 can be an audio file that is to be imported from a local music library stored on a user's local device to a cloud-based music library. The importation process results in the creation of a corresponding destination audio file 208 in the cloud-based music library. The local audio file 200 includes audio data 202 and associated metadata 204. In one embodiment, the import process includes direct copying of the audio data 202 of the local audio file 200 to audio data 210 of the destination audio file 208, so that audio data 210 is an exact copy of the audio data 202. In other embodiments, the audio data 202 can be processed (e.g. compressed, transcoded to a different file format, etc.) before being saved as audio data 210 of the corresponding destination audio file 208.

In the illustrated embodiment, a mapping template 206 defines mapping relationships between metadata fields of the local audio file and metadata fields of the destination audio file. The contents of a given metadata field in the local audio file may be copied directly to the same metadata field in the destination audio file. However, in other embodiments, there may be mappings which assign metadata fields in alternative ways. By way of example with continued reference to FIG. 4, the mapping template 206 has defined a mapping which switches metadata Fields A and B. In other words, Field A and Field B of the local audio file's metadata 204 are mapped to Field B and Field A, respectively, of the destination audio file's metadata 212, so that the contents from Field A of metadata 204 are copied to Field B of metadata 212, whereas the contents from Field B of metadata 204 are copied to Field A of metadata 212.

Another possibility is to merge the contents of two or more metadata fields into one metadata field. In the illustrated embodiment, the mapping template 206 defines a mapping between both of Field C and Field D of metadata 204 to the singular Field C of metadata 212. Thus, the contents of Field C and Field D of metadata 204 are merged in a specified manner to populate the singular Field C of metadata 212.

Yet another possibility is to map a single metadata field to multiple metadata fields. By way of illustration, the mapping template 206 maps Field E of metadata 204 to each of Field D and Field E of metadata 212. In some embodiments, the mapping may specify that Field D and Field E of metadata 212 will be populated with the same contents from Field E of metadata 204. In other embodiments, the mapping may specify that Field D and Field E of metadata 212 will each be populated with different portions of the contents of Field E of metadata 204 (e.g. non-overlapping or overlapping portions). For example, the mapping may specify that the content of Field E of metadata 204 be split at a particular character (e.g. a hyphen, parenthesis, etc.) to define the portions for each of Field D and Field E of metadata 212.

In some embodiments, the mapping template 206 can define more complex mapping relationships. For example, the mapping may define dependencies which govern the way in which contents are transferred from metadata fields of the local source audio file to the destination audio file. With continued reference to FIG. 4, by way of example, the mapping template 206 may define Field C of metadata 212 to be populated with the contents of Field C of metadata 204 if Field C of metadata 204 contains data, but alternatively be populated with the contents of Field D of metadata 204 if Field C of metadata 204 does not contain any data.

Another possibility is to set the contents of a particular destination file metadata field based on the value of a given source file metadata field. For example, there may be predefined contents for a destination file metadata field that are correlated to particular contents/values which may be found in a source file metadata field. Thus, if the source file metadata field contains a first particular content, then the destination file metadata field will be populated with a corresponding first predefined content; and if the source file metadata field contains a second particular content, then the destination file metadata field will be populated with a corresponding second predefined content; etc. The source file metadata field and the destination file metadata field can be the same metadata field type or different metadata field types. It will be appreciated by those skilled in the art that the mapping template 206 may define any of various types and combinations of mappings between metadata fields of the source audio file 200 and the destination audio file 208.

In some embodiments, the mapping template 206 can further define various types of modifications to metadata content, such as insertion or deletion of characters or content, conversion of recognized content to a different content, modification of recognized content, etc. By way of example, the mapping template can define a formatting 207 for the transfer of data from metadata fields of the local audio file 200 to the metadata fields of the destination audio file 208. The formatting 207 can define modifications to data from a source metadata field when written to a destination metadata field which alter the presentation format of the data. Examples of various modifications can include: insertion of characters for separation (e.g. spaces, hyphens, parentheses, brackets, quotations, or any other characters), rearrangement of content (e.g. switching a naming convention from first name first to last name first), etc. By way of example, if multiple fields are merged into a single field, then the formatting may specify the ordering of the data when merged and the insertion of separation characters between the merged data. It will be appreciated that any variety of formatting styles may be configured to provide for a desired format of data when transferred to the destination file metadata field.

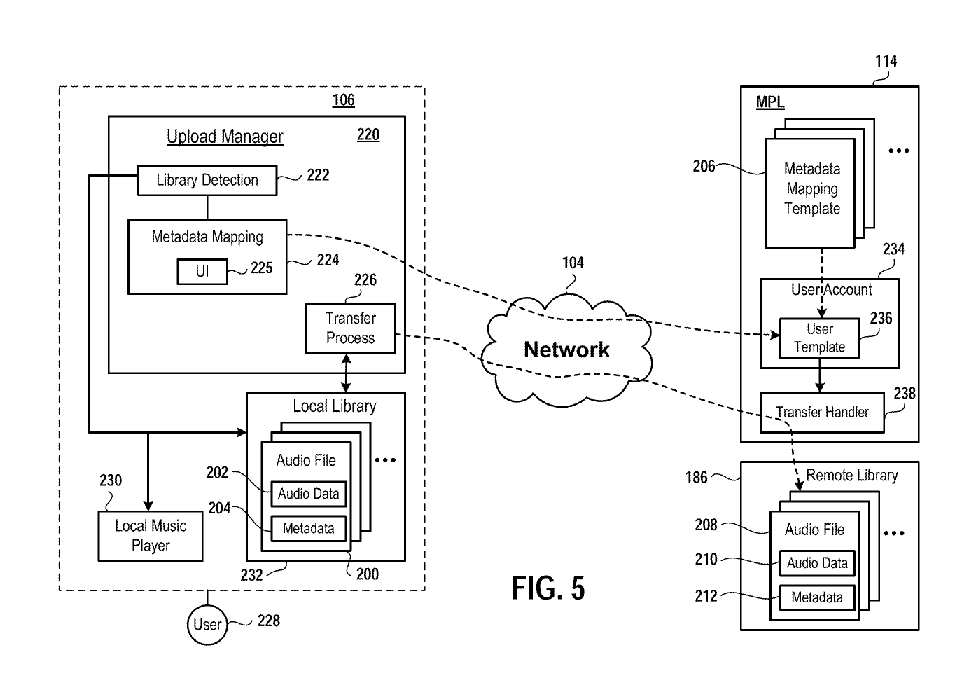

FIG. 5 illustrates a system for importing audio files to a cloud-based music service, in accordance with embodiments of the invention. The user 228 operates a device 230, which includes an upload manager 106 for uploading music files from a local library 232 to a remote library 186 of a cloud-based music service. The upload manager 220 includes a library detection module 222 which detects the local music library 232. In some embodiments, the library detection module 222 may also specifically detect the presence of a local music player 230 that is distinct from the cloud-based music service. The library detection module 222 is configured to determine the type of music library 232, e.g. by identifying the specific application with which the music library 232 is associated, or through recognition of characteristics of the music library 232 which indicate its type. In some embodiments, the user 228 may provide information to the upload manager 220 identifying the type of the local music library 232.

A metadata mapping module 224 defines a metadata mapping template that defines relationships between metadata of source audio files in the local music library 232 and metadata of destination audio files in the remote library 186. In one embodiment, based on the identified type of the local music library 232, the metadata mapping module 224 triggers retrieval of a metadata mapping template 206 associated with the identified type of the music library for use during import of music files from the local music library to the remote music library 186. In one embodiment, the retrieved template 206 can be a “blank” template which essentially maps all metadata field types to the same metadata field types without modification. In other embodiments, the retrieved template 206 is a default template associated with the identified type of the local library 232 that deviates from the aforementioned blank template in predefined ways based on known metadata configurations of the local library type. In some embodiments, the user 228 may modify the default template via a metadata mapping user interface 225 to create a user-defined mapping template 236 that is associated with the user's account 234 on the music service. The user-defined mapping template 236 can then be retrieved at a later date for future music file import activity.

According to the metadata mapping template (e.g. default or user-defined) utilized for the music uploading process, a transfer process 226 retrieves audio files from the local library 232 and uploads the appropriate data to the music provider logic 114. The MPL 114 includes a transfer handler 238 that receives the uploaded data and stores it to the remote library 186 according to the mapping template in use. As shown in the illustrated embodiment, audio data 202 from a source audio file 200 in the local music library 232 is thereby imported to define audio data 210 in a destination audio file 208 in the remote music library 186, and metadata 204 from the source audio file 200 is imported to define metadata 212 in the destination audio file 208.

In the illustrated embodiment, the metadata mapping module 224 is defined as part of the upload manager 220 on the device 106. However, in other embodiments, the metadata mapping module 224 may be remotely defined, for example, as part of the music provider logic 114. In some embodiments, the upload manager 220 can be defined as a webpage which may be accessed via a browser application or other application provided on the device 106.

Though it is generally assumed that metadata associated with a particular audio file is included as part of that file, there may be music players which associate metadata with audio files, but store the metadata separately from the actual audio file. It will be understood by those skilled in the art that the concepts described herein are readily applied to include the mapping and import of such metadata.

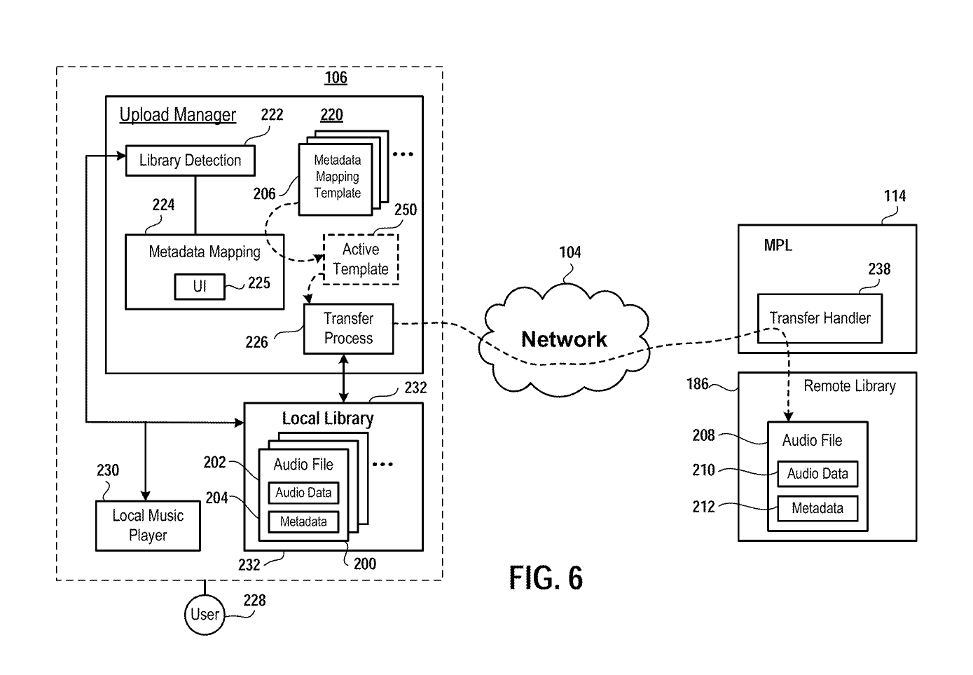

FIG. 6 illustrates a system for importing music files from a local music library 232 to a remote music library 186, in accordance with embodiments of the invention. The illustrated embodiment of FIG. 6 differs from that of FIG. 5 primarily in that metadata mapping templates are provided and stored on the client device 106 by the upload manager 220. As shown, the metadata mapping template 206 is accessed and defined via the metadata mapping module 224 in accordance with detection of the local music library 232 by the library detection module 222. The metadata mapping UI 225 can be utilized by the user 228 to modify the mapping template 206, or the mapping template 206 may be utilized as is. In one embodiment, the selected mapping template 206 defines an active template 250, according to which the transfer process 226 transfers data from the audio files of the local library 232 to the remote library 186.

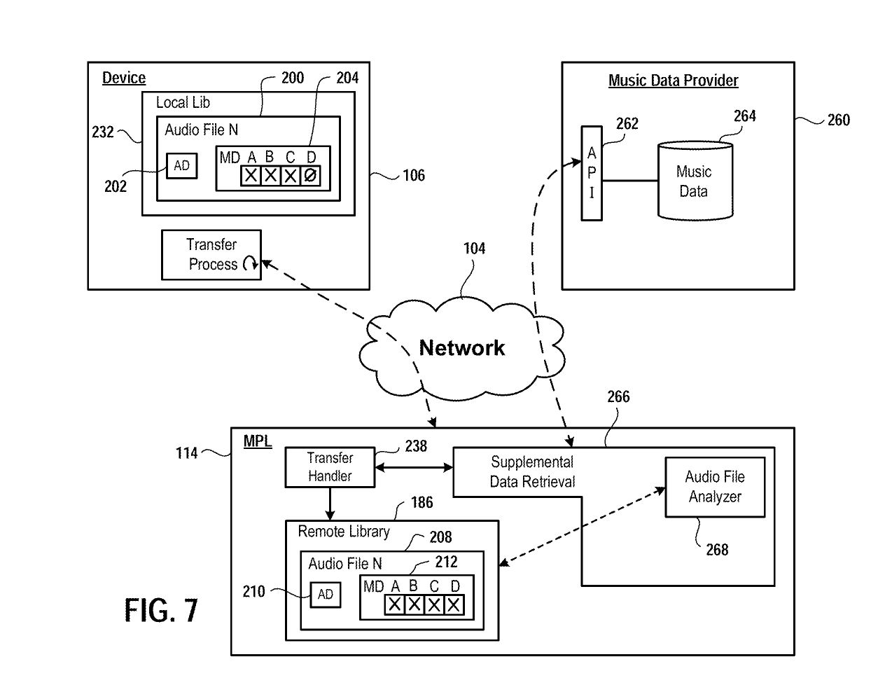

FIG. 7 illustrates a system for supplementing metadata from a data provider, in accordance with embodiments of the invention. In the illustrated embodiment, the local music library 232 includes an audio file 200 having audio data 202 and metadata 204. The metadata 204 includes various metadata fields A, B, C, and D. However, while metadata fields A, B, and C contain data, the metadata field D of the audio file 200 does not contain any data. Thus, when the audio file 200 is imported to the remote music library 208, there is no data from the source audio file 200 that may be utilized to populate a corresponding metadata field in the destination audio file 208 to which the metadata field D has been mapped. By way of example in the illustrated embodiment, the field D of the source audio file 200 has been mapped to the same type of metadata field, a metadata field D, in the destination audio file 208. Thus, if the metadata field D of the source audio file 200 contains no data, then the corresponding field D of the destination audio file 208 will also contain no data. This may be problematic if the music provider logic 114 of the cloud-based music service is reliant upon or otherwise utilizes the data of metadata field D.

Therefore, in accordance with embodiments of the invention, a supplemental data retrieval module 266 is provided to supplement the metadata of the destination audio file 208 when deficiencies occur, such as when the source audio file 200 lacks data in a particular metadata field. Broadly speaking, the supplemental data retrieval module 266 communicates with a music data provider 260 to retrieve supplemental data which can be utilized to populate metadata fields of audio files in the remote music library 186. The supplemental data retrieval module 266 includes an audio file analyzer 268 that performs analysis of a given audio file, to either determine the canonical identification of the audio file or determine parameters which can be utilized by the music data provider 260 to determine its canonical identification.

The supplemental data retrieval module 266 communicates with an API 262 of the music data provider 260 to retrieve relevant data stored in a music data storage 264 of the music data provider 260. The retrieved data is utilized to populate a metadata field of an audio file in the remote library 186 that may be deficient, such as the field D in the audio file 208. In this manner, though the source audio file 200 lacked data in the metadata field D, its corresponding metadata field in the destination audio file 208 can be populated with appropriate data based on the supplemental data retrieved from the music data provider 260. It will be appreciated that the music data provider 260 can be accessible over the network 104, which can be any type of data network.

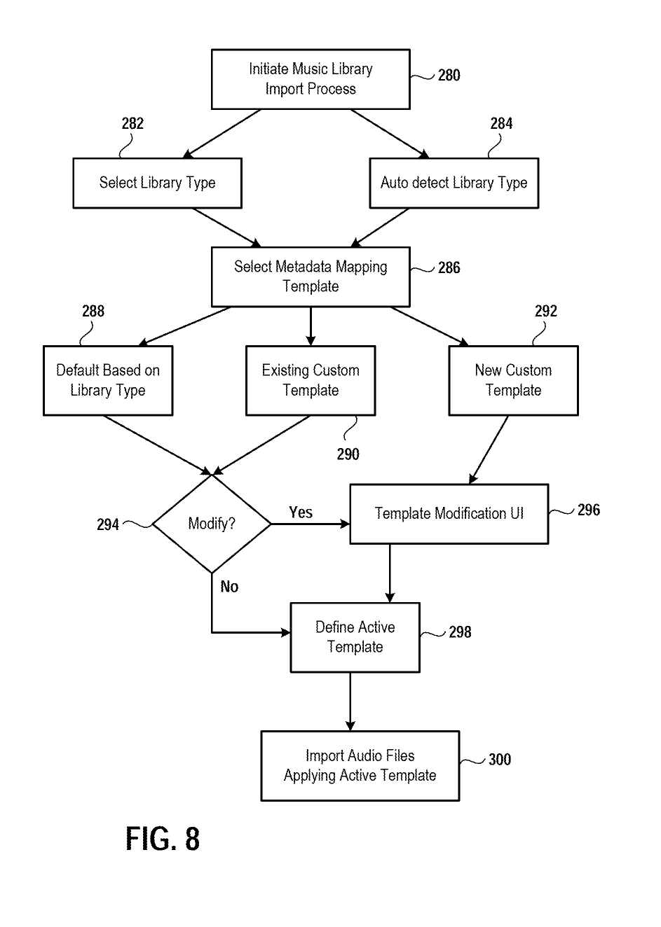

FIG. 8 illustrates a method for importing music from an existing music library to a destination music library, in accordance with embodiments of the invention. At operation 280, a music library import process is initiated. According to the import process, a user a may select or otherwise identify a library type for the existing music library, as indicated by operation 282. In the alternative, an autodetection process may determine the library type of the existing music library, as indicated by operation 284. At operation 286, a metadata mapping template is selected.

In one embodiment, as provided by operation 288, the metadata mapping template is a default template based on the library type of the existing music library. At operation 294, the user has the option to modify the default mapping template. If the user decides not to modify the default template, then it is applied as is to define an active template at operation 298. If the user chooses to modify the default mapping template, then at operation 296, a template modification UI is presented to enable to user to make modifications before applying the template to define the active template at operation 298.

In another embodiment, as indicated by operation 290, the metadata mapping template is an existing custom template. As with the previously discussed default template, the user has the option to modify the existing custom template via a template modification UI prior to its being applied to define the active template at operation 298.

In yet another embodiment, as provided at operation 292, the metadata mapping template is a new custom template. At operation 296, the user modifies the new custom template via the template modification UI. The new custom template is then utilized to define the active template at operation 298.

At operation 300, the audio files from the existing music library are imported to the destination music library. The metadata from the audio files is imported based on relationships and applying processing/modification as defined by the active template.

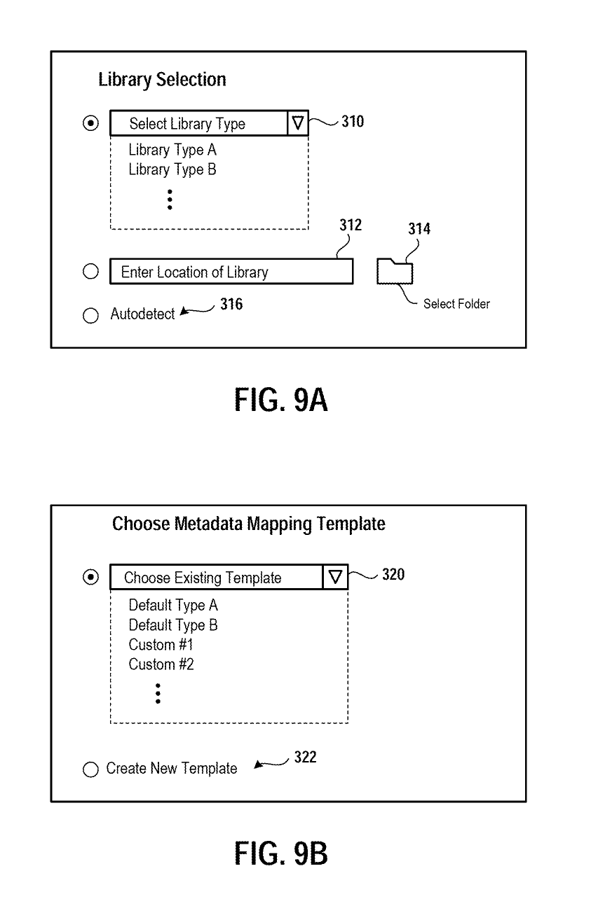

FIG. 9A illustrates a library selection interface for enabling a user to define an existing music library from which to import music to a second music library, in accordance with embodiments of the invention. In the illustrated embodiment, the user may choose from various options for selecting a music library. The first selection option is indicated by the selection menu 310, from which the user may select a particular library type. By way of example, the library types listed can include music libraries which are associated with particular music or media players. In one embodiment, the listing of music library types is generated through automated detection of existing music/media players or music libraries on the user's device. A second option is for the user to enter the location of the library within the file system of the device. In the illustrated embodiment, the user can enter the file system path in a field 312, or bring up a folder navigation interface by selecting the icon 314 from which the user may navigate to the location of the library. A third option is for the user to select an autodetect mode 316, which triggers a detection process to search the user's device for a music library or for audio files.

FIG. 9B illustrates a selection interface for choosing a metadata mapping template, in accordance with embodiments of the invention. In the illustrated embodiment, the user may choose an existing template from a menu 320, or choose to create a new template as indicated by reference 322. The existing templates listed as part of the menu 320 can include various template types, such as default templates associated with specific music/media library types, predefined custom templates, etc.

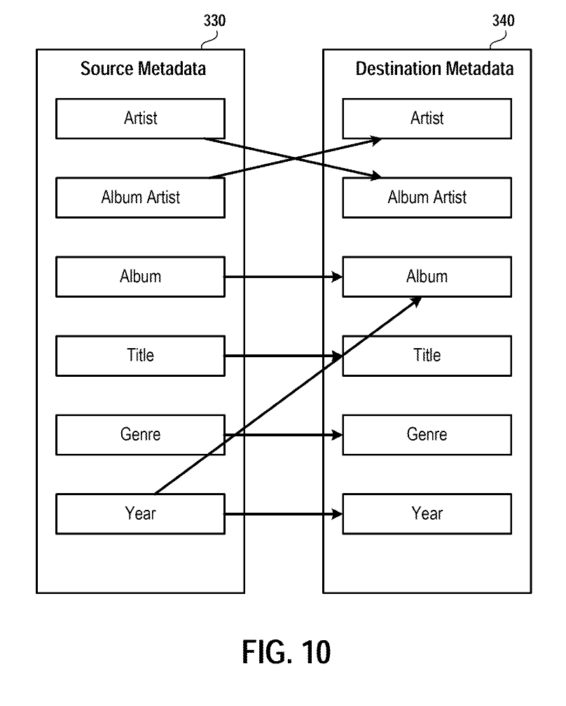

FIG. 10 illustrates a mapping interface for defining metadata mapping relationships between a source audio file and a destination audio file, in accordance with embodiments of the invention. In the illustrated embodiment, a graphical representation 330 of the source metadata is displayed at left, while a graphical representation 340 of the destination metadata is displayed at right. The metadata fields include fields for Artist, Album Artist, Album, Title, Genre, and Year, by way of example and not by way of limitation. In one embodiment, the user can define mapping relationships by drawing connecting lines between the graphically represented metadata fields of the source metadata and metadata fields of the destination metadata.

In the illustrated embodiment, the Artist field of the source metadata has been mapped to the Album Artist field of the destination metadata, and the Album Artist field of the source metadata has been mapped to the Artist field of the destination metadata. In typical usage, the artist metadata field defines the performer of a specific song, whereas the album artist metadata field defines the entity associated or credited with the entire album in which the song appears. Often the artist and the album artist are the same person or entity. However, in albums such as compilation albums or other albums with songs performed by different artists, the artist of a particular song will often be different from the album artist associated with the album as a whole.

With continued reference to FIG. 10, it may be the case that the music player associated with the source music library sorts according to the Artist field. However, the destination music player may sort according to the Album Artist field. Therefore, when importing music from the source music library to the destination library, it may be desirable to switch the Artist and Album Artist metadata fields in order to preserve a similar sorted order of music upon import of the source music library to the destination music library. In this way, the user is able to import their music library from one music player to another while preserving the sorted ordering of songs with which they are already familiar. In another embodiment, it may be desirable to map the metadata fields such that the Album Artist field of the destination metadata is populated with the contents of the Album Artist field of the source metadata if available, but if not available, then populated with the contents of the Artist field of the source metadata instead.

With continued reference to FIG. 10, in the illustrated embodiment, both of the Album and Year fields of the source metadata have been mapped to the Album field of the destination metadata. Therefore, in one embodiment, the contents of the Album and Year fields of the source metadata are merged and utilized to populate the singular Album field of the destination metadata.

It will be appreciated that the examples of mapping configurations described herein, including mapping a field to a different field type, contingent population of a destination field, and merging of fields to populate a single field, are merely specific examples provided by way of illustration only. Similar mapping configurations can be constructed for any other metadata fields, in accordance with other embodiments.

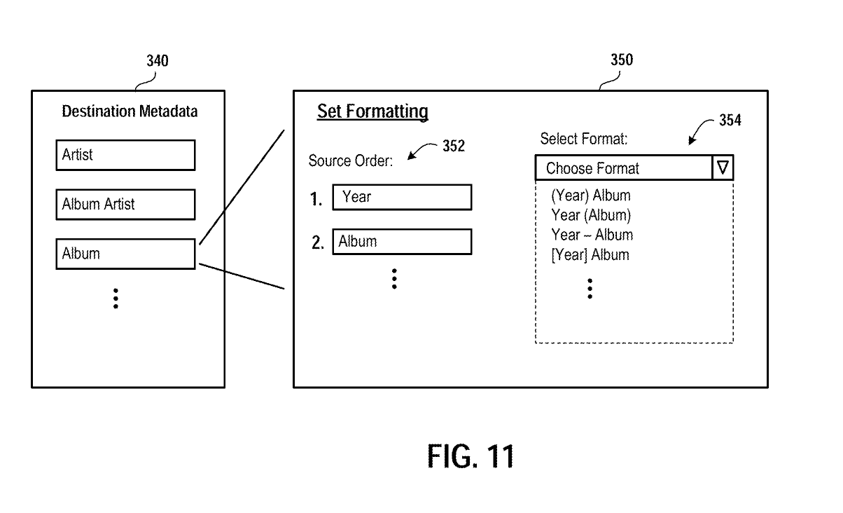

FIG. 11 illustrates an interface for setting the format of a particular metadata field, in accordance with embodiments of the invention. In the illustrated embodiment, the user is able to access a format setting interface 350 for adjusting the formatting of the Album field of the destination metadata. In an order setting section 352, the user can adjust the order in which contents from the source metadata fields are presented. In a formatting section 354, the user can choose from various formatting options presented in a menu. By way of example, contents from a source metadata field may be presented in parentheses, brackets, or other delineating characters, and the contents from multiple source metadata fields may be separated by characters such as a hyphen, etc. These formatting examples are provided by way of example only, and it will be appreciated that in other embodiments, there may be any number of formatting possibilities which are selectable or adjustable by the user.

Though embodiments have been described generally with reference to cloud-based music services, it will be appreciated by those skilled in the art that the concepts presented in accordance with various embodiments of the invention may be readily applied to any of various other types of music applications and services. In particular, it will be appreciated that the concepts relating to mapping of metadata between different music libraries can be applied to any two different music libraries, including music libraries associated with cloud-based as well as non-cloud based systems. While embodiments have made specific mention of metadata mapping from a local music library to a cloud-based music library, the concepts thus described may be applied to import of music files from a cloud-based music library to a local music library, and may further be applied between two local music libraries and two cloud based libraries.

It will be appreciated that the mappings between metadata fields of a source audio file and a destination audio file can be configured in a great variety of ways for various reasons specific to the user's situation. For example, the user may have a library of music containing classical music tracks, which are sorted by the composer metadata field by the source music player. However, the destination music player may sort by artist, and may even ignore the composer field altogether. In such a scenario, it may be desirable for the user to define a metadata mapping which maps the composer field of the source audio files to the artist field of the destination audio files, so that when imported to the destination library, the classical music tracks will retain their sorting by the “composer” of the music, even though the destination music player is actually sorting the artist metadata field.

In another example, it may be the case that audio files in the source library contain valuable information in a particular metadata field; however, the destination music player may not support that metadata field. For example, there may be lyrics data contained in the lyrics metadata field of the source audio files. However, the destination music player may not support the lyrics metadata field, and therefore will not upload the data from the lyrics metadata field. Consequently, the lyrics data would normally be lost upon uploading of the audio files to the destination music library. However, in such a scenario, it may be desirable to map the lyrics metadata field to another metadata field type that is supported by the destination music player. For example, perhaps the genre metadata field is supported by the destination music player. The user can therefore map the lyrics metadata field of the source music files to the genre metadata field of the destination music files, thereby preserving the lyrics data upon import in the genre metadata field of the destination music files.

In another example, a user may utilize a rating metadata field in a customized way. In ordinary usage, the rating field is generally intended to provide a numerical value indicating how much a user likes a particular song. However, users may utilize the rating field for any variety of purposes that may or may not relate to how much the user actually likes the song. Therefore, when importing music files from a source music library to a destination music library, if the rating field is not being utilized in a customary manner, then the destination music player may interpret the rating field in a way that does not suit the user's intention. Thus, in accordance with embodiments of the invention described herein, the user may define a custom mapping which maps the rating field of the source music file to a particular metadata field in the destination music file. Furthermore, the user may configure the mapping to define various values for the particular metadata field in the destination music file which correspond to values or value ranges in the rating field of the source music file. For example, the mapping may define the particular metadata field of the destination music file to have a first value if the value of the rating field of the source music file is in a first range, and a second value if the value of the rating field of the source music file is in a second range, etc. Or another possibility is for the mapping to define a scaling between the value of the rating field of the source music file and a value of the particular metadata field of the destination music file.

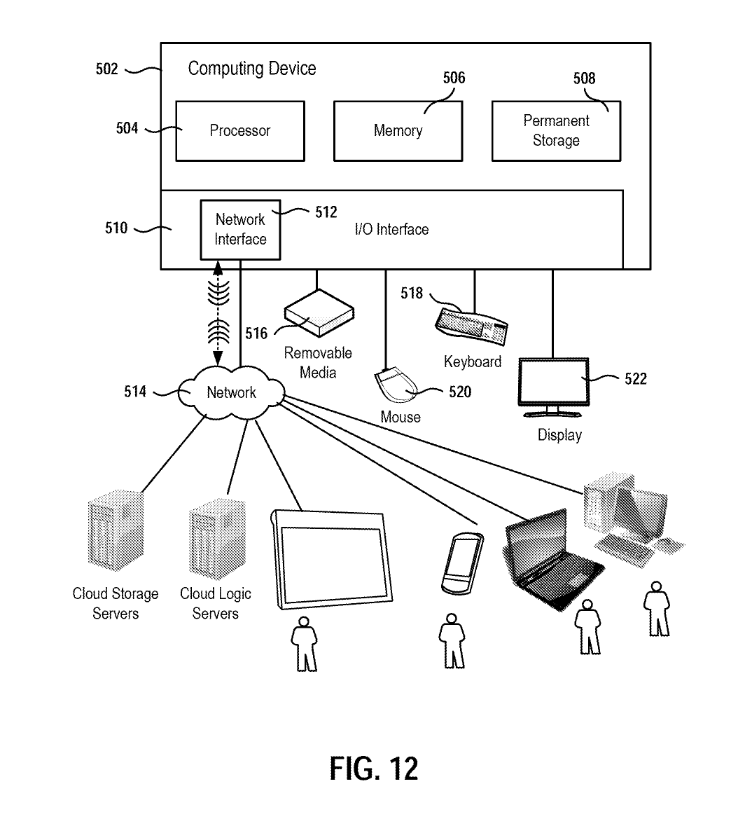

FIG. 12 is a simplified schematic diagram of a computer system 502 for implementing embodiments of the present invention. FIG. 12 depicts an exemplary computer environment for implementing embodiments of the invention. It should be appreciated that the methods described herein may be performed with a digital processing system, such as a conventional, general-purpose computer system. Special purpose computers, which are designed or programmed to perform only one function, may be used in the alternative. The computer system 502 includes a processor 504, which is coupled through a bus to memory 506, permanent storage 508, and Input/Output (I/O) interface 510.

Permanent storage 508 represents a persistent data storage device such as a hard drive or a USB drive, which may be local or remote. Network interface 512 provides connections via network 514, allowing communications (wired or wireless) with other devices. It should be appreciated that processor 504 may be embodied in a general-purpose processor, a special purpose processor, or a specially programmed logic device. Input/Output (I/O) interface 510 provides communication with different peripherals and is connected with processor 504, memory 506, and permanent storage 508, through the bus. Sample peripherals include display 522, keyboard 518, mouse 520, removable media device 516, etc.

Display 522 is configured to display the user interfaces described herein. Keyboard 518, mouse 520, removable media device 516, and other peripherals are coupled to I/O interface 510 in order to exchange information with processor 504. It should be appreciated that data to and from external devices may be communicated through I/O interface 510. Embodiments of the invention can also be practiced in distributed computing environments where tasks are performed by remote processing devices that are linked through a wired or a wireless network.

Embodiments of the present invention can be fabricated as computer readable code on a non-transitory computer readable storage medium. The non-transitory computer readable storage medium holds data that can be read by a computer system. Examples of the non-transitory computer readable storage medium include permanent storage 508, network attached storage (NAS), read-only memory or random-access memory in memory module 506, Compact Discs (CD), Blu-ray™ discs, flash drives, hard drives, magnetic tapes, and other data storage devices. The non-transitory computer readable storage medium may be distributed over a network-coupled computer system so that the computer readable code is stored and executed in a distributed fashion.

Additionally, FIG. 12 shows various types of devices that can connect to the network, such as the Internet. The devices include servers, tablet computers, smartphones, laptops, desktops, etc. The various devices can run operating systems, and the operating systems can vary from manufacturer to manufacturer.

Some, or all operations of the method presented herein are executed through a processor, such as processor 504 of FIG. 12. Additionally, although the method operations were described in a specific order, it should be understood that some operations may be performed in a different order, when the order of the operations do not affect the expected results. In addition, other operations may be included in the methods presented, and the operations may be performed by different entities in a distributed fashion, as long as the processing of the operations is performed in the desired way.

In addition, at least one operation of some methods performs physical manipulation of physical quantities, and some of the operations described herein are useful machine operations. Embodiments presented herein recite a device or apparatus. The apparatus may be specially constructed for the required purpose or may be a general purpose computer. The apparatus includes a processor capable of executing the program instructions of the computer programs presented herein.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

What is claimed is:

1: A processor-implemented method for uploading a music library to a music service provider, comprising:
identifying a music library for uploading, the music library including at least one music file, the music file including audio data and associated metadata fields;
defining a mapping between the metadata fields of the music file and metadata fields of a destination file corresponding to the music file, wherein the mapping defines an association between a metadata field of the music file having a first type and a metadata field of the destination file having a second type different from the first type;
creating the destination file at the music service provider by copying the audio data to the destination file and by copying contents of the metadata fields of the music file to the metadata fields of the destination file according to the mapping.

2: The processor-implemented method of claim 1,
wherein copying contents of the metadata fields of the music file to the metadata fields of the destination file includes copying contents, from the metadata field of the music file having the first type, to the metadata field of the destination file having the second type different from the first type.

3: The processor-implemented method of claim 2, wherein the first type and the second type are selected from the group consisting of artist, album artist, album, title, genre, and year.

4: The processor-implemented method of claim 1, wherein defining the mapping includes presenting an interface for defining associations between the metadata fields of the music file and the metadata fields of the destination file, and receiving input via the interface.

5: The processor-implemented method of claim 1,
wherein the mapping defines an association between two metadata fields of the music file and a single metadata field of the destination file; and
wherein copying contents of the metadata fields of the music file to the metadata fields of the destination file includes merging contents from the two metadata fields of the music file and writing the merged contents to the single metadata field of the destination file.

6: The processor-implemented method of claim 1,
wherein the mapping defines an association between a single metadata field of the music file and two metadata fields of the destination file; and
wherein copying contents of the metadata fields of the music file to the metadata fields of the destination file includes copying contents from the single metadata field of the music file to each of the two metadata fields of the destination file.

7: A computer-readable storage device having program instructions for uploading a music library to a music service provider embodied thereon that, in response to execution by a computing device, cause the computing device to perform operations comprising:
identifying a music library for uploading, the music library including at least one music file, the music file including audio data and associated metadata fields;
defining a mapping between the metadata fields of the music file and metadata fields of a destination file corresponding to the music file, wherein the mapping defines an association between a metadata field of the music file having a first type and a metadata field of the destination file having a second type different from the first type;
creating the destination file at the music service provider by copying the audio data to the destination file and by copying contents of the metadata fields of the music file to the metadata fields of the destination file according to the mapping.

8: The computer-readable storage device of claim 7,
wherein copying contents of the metadata fields of the music file to the metadata fields of the destination file includes copying contents, from the metadata field of the music file having the first type, to the metadata field of the destination file having the second type different from the first type.

9: The computer-readable storage device of claim 8, wherein the first type and the second type are selected from the group consisting of artist, album artist, album, title, genre, and year.

10: The computer-readable storage device of claim 7, wherein defining the mapping includes presenting an interface for defining associations between the metadata fields of the music file and the metadata fields of the destination file, and receiving input via the interface.

11: The computer-readable storage device of claim 7,
wherein the mapping defines an association between two metadata fields of the music file and a single metadata field of the destination file; and
wherein copying contents of the metadata fields of the music file to the metadata fields of the destination file includes merging contents from the two metadata fields of the music file and writing the merged contents to the single metadata field of the destination file.

12: The computer-readable storage device of claim 7,
wherein the mapping defines an association between a single metadata field of the music file and two metadata fields of the destination file; and
wherein copying contents of the metadata fields of the music file to the metadata fields of the destination file includes copying contents from the single metadata field of the music file to each of the two metadata fields of the destination file.

13: A system comprising at least one computing device for uploading a music library to a music service provider, including:
a library identification module for identifying a music library for uploading, the music library including at least one music file, the music file including audio data and associated metadata fields;
a mapping module for defining a mapping between the metadata fields of the music file and metadata fields of a destination file corresponding to the music file, wherein the mapping defines an association between a metadata field of the music file having a first type and a metadata field of the destination file having a second type different from the first type;
a transfer module for creating the destination file at the music service provider by copying the audio data to the destination file and by copying contents of the metadata fields of the music file to the metadata fields of the destination file according to the mapping.

14: The system of claim 13,
wherein copying contents of the metadata fields of the music file to the metadata fields of the destination file includes copying contents, from the metadata field of the music file having the first type, to the metadata field of the destination file having the second type different from the first type.

15: The system of claim 14, wherein the first type and the second type are selected from the group consisting of artist, album artist, album, title, genre, and year.

16: The system of claim 13, wherein defining the mapping includes presenting an interface for defining associations between the metadata fields of the music file and the metadata fields of the destination file, and receiving input via the interface.

17: The system of claim 13,
wherein the mapping defines an association between two metadata fields of the music file and a single metadata field of the destination file; and
wherein copying contents of the metadata fields of the music file to the metadata fields of the destination file includes merging contents from the two metadata fields of the music file and writing the merged contents to the single metadata field of the destination file.

18: The system of claim 13,
wherein the mapping defines an association between a single metadata field of the music file and two metadata fields of the destination file; and
wherein copying contents of the metadata fields of the music file to the metadata fields of the destination file includes copying contents from the single metadata field of the music file to each of the two metadata fields of the destination file.
